(19) United States
(12) Patent Application Publication
(10) Pub. No.: US 2007/0083905 A1
(43) Pub. Date: Apr. 12, 2007

(54) Media player, control method thereof, and media play system having the same

(75) Inventor: Chang-jin Lee, Suwon-Si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/402,851

(22) Filed: Apr. 13, 2006

(30) Foreign Application Priority Data
Jul. 22, 2005 (KR) 2005-0066842

(51) Int. Cl. H04N 7/173

(52) U.S. Cl. 725/105

(57) ABSTRACT

The present invention relates to a media play system comprising a media player and a media interface in which a signal is transmitted from an external source to the media player. The media interface includes a cable to transmit the signal, and a memory to store cable information about characteristics of the cable. The media player includes a connection unit connected to the cable, a signal processor that processes a signal input through the connection unit, and a controller that processes the input signal through the connection unit in accordance with the cable information. Thus, the present invention provides a media player, a control method thereof, and a media play system including the same, in which a signal is optimally processed according to characteristics of a connection cable.

### CROSS-REFERENCE TO RELATED APPLICATIONS

This application claims the benefit under 35 U.S.C. § 119(a) of Korean Patent Application No. 2005-0066842, filed on Jul. 22, 2005, in the Korean Intellectual Property Office, the entire disclosure of which is hereby incorporated by reference.

### BACKGROUND OF THE INVENTION

1. Field of the Invention

The present invention relates to a media player, a control method thereof, and a media play system including the same. More particularly, the present invention relates to a media player capable of receiving and processing a signal from an external source, a control method thereof, and a media play system including the same.

2. Description of the Related Art

A conventional display apparatus, which displays an image based on a received video signal, generally employs a connection cable to receive the video signal from a signal source. The connection cable is designed variously according to a type of transmission signal. The connection cable length is also variously provided. For example, a high definition multimedia interface (HDMI) cable has a length of 7 m or more, and noise is generated according to design characteristics of the cable (for example, a star cable).

A display apparatus processes a signal transmitted through the connection cable, thereby displaying an image. Consequently, a signal processing operation is performed to compensate noise such as signal loss and signal weakening generated in the connection cable. Here, the display apparatus processes the received signal in accordance with a register value related to noise compensation.

The register value related to the noise compensation is set by a designer while the display apparatus is produced. The designer sets the register value by an optimal value to reserved connection cables, while the display apparatus is developed. That is, the designer tests noise in many reserved cables, thereby setting an optimal register value in which an image has little noise.

However, when a user does not use the optimal connection cable, which is tested by a developer when the display apparatus is designed, but uses another connection cable having different characteristics, noise may be generated. For example, when a user uses the connection cable having a length longer or shorter than 7 m, although a predetermined length under a condition that the register value is set to the connection cable having a length of 7 m, noise is likely to occur in processing the signal.

Accordingly, there is a need for an improved method for processing a signal in a connection cable in a media play system, according to the connection cable characteristics.

### SUMMARY OF THE INVENTION

An aspect of embodiments of the present invention is to address at least the above problems and/or disadvantages and to provide at least the advantages described below. Accordingly, an aspect of embodiments of the present invention is to provide a media player, a control method thereof, and a media play system including the same, in which a signal is optimally processed according to characteristics of a connection cable.

The foregoing and/or other aspects of an exemplary embodiment of the present invention can be achieved by providing a media play system comprising a media player and a media interface which a signal is transmitted from an external source to the media player. The media interface includes a cable to transmit the signal, and a memory to store cable information about characteristics of the cable. The media player includes a connection unit, which the cable is connected to, a signal processor that processes a signal input through the connection unit, and a controller that processes the input signal through the connection unit on the basis of the cable information.

According to another exemplary embodiment of the present invention, the cable information includes information about at least one of length, impedance or capacitance of the cable.

According to another exemplary embodiment of the present invention, the media player comprises a register to process noise of the signal. The controller determines an optimal register value for the noise process according to the characteristics of the cable by reading the cable information, and controls the signal processor to process the noise of the signal input through the connection unit on the basis of the optimal register value.

According to another exemplary embodiment of the present invention, the signal processor comprises a transition minimized differential signaling (TMDS) receiver.

According to another exemplary embodiment of the present invention, the media interface comprises a high-definition multimedia interface (HDMI) cable.

According to another exemplary embodiment of the present invention, the controller comprises at least one of a micro controller (MCU) or a central processing unit (CPU).

The foregoing and/or other aspects of an exemplary embodiment of the present invention can be achieved by providing a media player comprising a connection unit, which a media interface cable is connected to, for transmitting a signal from an external source. The media player includes a signal processor to process a signal input through the connection unit. A controller reads cable information about characteristics of the media interface cable from a memory provided in the media interface cable, where the media interface cable is connected to the connection unit, and controls the signal processor to process the input signal in accordance with the cable information.

According to another exemplary embodiment of the present invention, the cable information includes information about at least one of the length, the impedance or the capacitance of the media interface cable.

According to another exemplary embodiment of the present invention, the signal processor comprises a TMDS receiver.

According to another exemplary embodiment of the present invention, the media interface cable comprises an HDMI cable.

According to another exemplary embodiment of the present invention, the controller comprises at least one of a MCU or a CPU.

According to another exemplary embodiment of the present invention, the MCU is provided in the TMDS receiver.

According to another exemplary embodiment of the present invention, the MCU and the CPU read the cable information from the memory through 12 C communication.

According to another exemplary embodiment of the present invention, the memory comprises an electrical erasable programmable read only memory (EEPROM).

According to another exemplary embodiment of the present invention, the media player further comprises a register to process noise of the signal, wherein at least one of the MCU or the CPU determines an optimal register value according to the characteristics of the media interface cable by reading the cable information from the memory, and controls the TMDS receiver to process the noise of the input signal in accordance with the optimal register value.

The foregoing and/or other aspects of an exemplary embodiment of the present invention can be achieved by providing a method of controlling a media player including a connection unit, which an HDMI cable is connected to, for transmitting a signal from an external source to a media player. The method includes an optimal register value determined for processing noise of a signal according to characteristics of the HDMI cable by reading information about at least one of length, impedance or capacitance of the HDMI cable from a predetermined memory provided in the HDMI cable, where the HDMI cable is connected to the connection unit; and processing the noise of the signal received through the connection unit on the basis of the optimal register value.

Other objects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompany drawings, in which:

FIG. 1 is a control block diagram of a display apparatus and a system thereof according to an exemplary embodiment of the present invention;

FIG. 2 is a control block diagram of a display apparatus and a system thereof according to an exemplary embodiment of the present invention; and

FIG. 3 is a control flowchart of the display apparatus according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

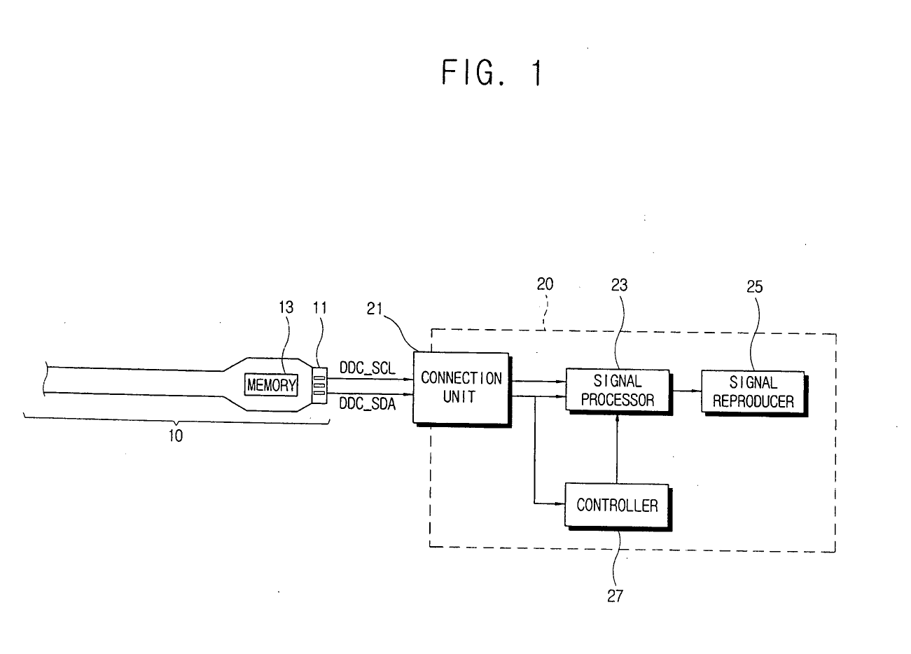

FIG. 1 is a control block diagram of a display apparatus and system according to an exemplary embodiment of the present invention.

As shown in FIG. 1, a display system includes a connection cable 10 through which a signal is transmitted from an external source (not shown) to a display apparatus 20. The display apparatus 20 displays an image by processing the transmitted signal.

The connection cable 10 includes a connector to be connected to a signal output port of the external source and a connection unit (that is, signal input port) 21 of the display apparatus 20; a signal transmission line (not shown) through which the signal output from the external source is transmitted, and a memory 13 storing cable information about the characteristics of the connection cable 10.

Here, the cable information stored in the memory 13 includes length, impedance and/or capacitance of the connection cable 10, and can be stored while the connection cable 10 is produced. The memory 13 includes an erasable programmable read only memory (EPROM) or an electrical erasable programmable read only memory (EEPROM). Here, the connection cable 10 is designed variously according to the type of transmission signal.

The display apparatus 20 according to an exemplary embodiment of the present invention includes the connection unit 21 connected to the connector 11 of the connection cable 10; a signal processor 23 that processes the transmitted received signal; a signal reproducer 25 that reproduces a picture and/or a sound based on the processed signal; and a controller 27.

The connection unit 21 is connected with the connection cable 10, and receives video signals corresponding to various external sources. For example, the connection unit 21 includes input terminals for a composite video baseband signal (CVBS), S-video signal, component signal, personal computer (PC) signal, digital video/visual interactive (DVI) signal, and a high-definition multimedia interface (HDMI) signal.

The signal processor 23 may include a video processor to process a video signal received through the connection unit 21, and an audio processor to process an audio signal received through the connection unit 21. The signal reproducer 25 may include a display unit to display a picture based on the video signal, and a speaker unit to output a sound based on the audio signal. Further, the signal processor 23 includes an equalization circuit to compensate loss in signal transmission.

Here, the video processor processes the received video signal to have a format suitable for the display unit. According to an exemplary embodiment of the present invention, the video processor includes various signal processing integrated chips (IC) such as a color signal separator, analog-digital converter (ADC), transition minimized differential signaling (TMDS) receiver, video decoder, de-interlacer, scaler, and picture-quality enhancer.

When the connection unit 21 is connected with the connection cable 10, the controller 27 reads cable information from the memory 13 provided in the connection cable 10, and controls the signal processor 23 to process the received signal according to characteristics of the cable. Here, the controller 27 may be a microcomputer or a CPU.

The transmission signal is weakened in the connection cable 10, so there is a need to compensate loss in amplification or noise process. Therefore, the controller 27 determines signal enhancement according to the length of the connection cable 10, and controls the equalization circuit of the signal processor 23 to variously apply loss compensation such as the amplification, noise process, or the like, to the received signal in consideration of each connection cable 10. Thus, the noise process is varied corresponding to the connection cable 10, so that the display apparatus can secure a reproducing condition according to the connection cable 10.

According to an exemplary embodiment of the present invention, the display apparatus 20 includes a register for the noise process. The controller 27 reads the cable information from the memory 13 of the connection cable 10, and determines an optimal register value to the noise process, thereby setting the register value. Then, the signal processor 23 processes the signal on the basis of the set register value. These operations will be described in more detail below.

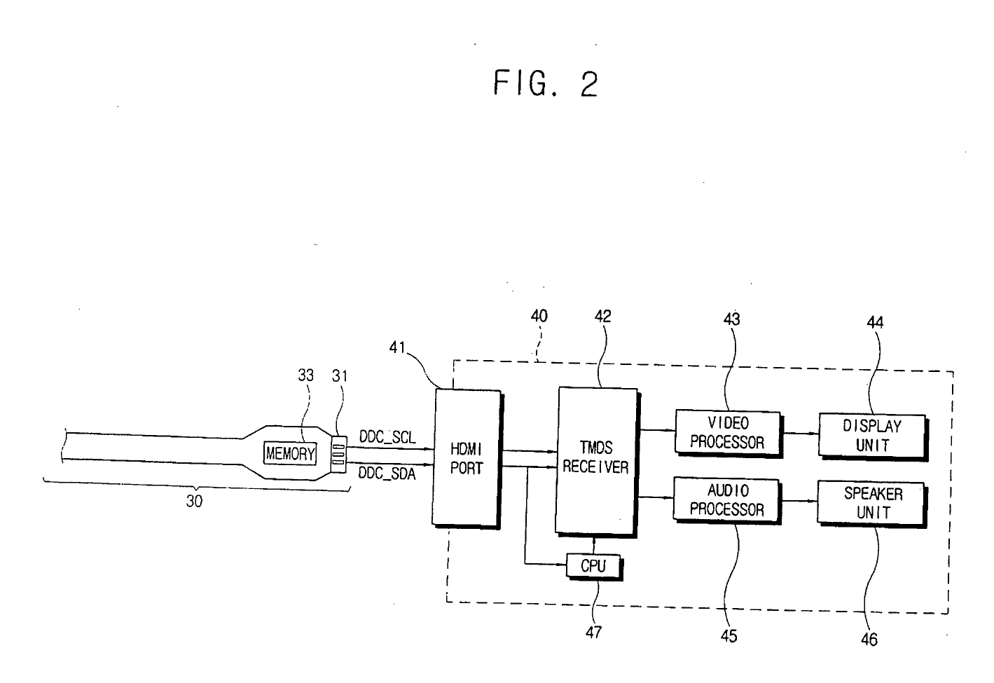

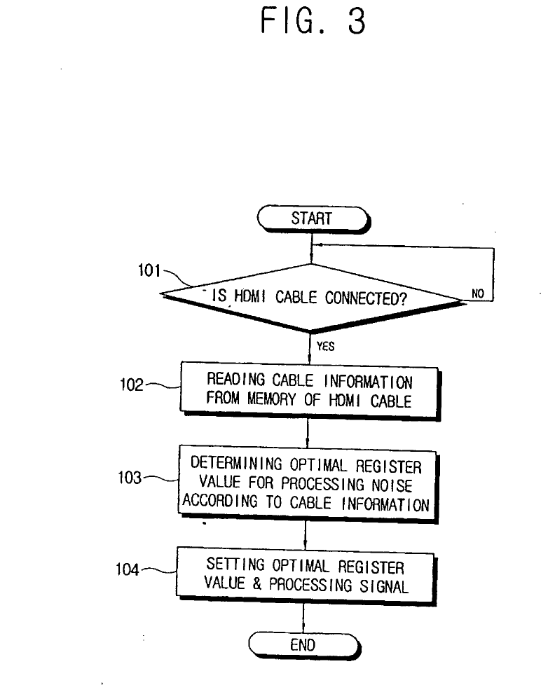

A display apparatus 40 according to an exemplary embodiment of the present invention and its system will be described with reference to FIGS. 2 and 3, and repetitive descriptions will be avoided for clarity and conciseness.

shown in FIG. 2, the display system according to an exemplary embodiment of the present invention includes an HDMI cable 30 through which an HDMI signal is transmitted from an external source, and a display apparatus 40 to process and reproduce the HDMI signal.

The HDMI cable 30 transmits a TMDS digital signal from the external source to the display apparatus 40. Here, the HDMI cable 30 includes a memory 33 to store cable information such as length, inductance, and capacitance of the HDMI cable 30. As described above, the cable information stored in the memory 33 is varied according to characteristics of the cable. Here, the HDMI standards allow appendix data, a video signal, audio signal, and control signal to be transmitted through one cable during a blanking period. For example, the HDMI cable 30 transmits clock and data through a DDC_SCL line and a DDC_SDA line.

The display apparatus 40 according to an exemplary embodiment of the present invention includes an HDMI port 41 connected to the HDMI cable 30; a TMDS receiver 42 that processes the HDMI signal by separating the TMDS receiver into the video signal, the audio signal and control signal; a video processor 43 and audio processor 45 that processes the separated video and audio signals to output standards of a display unit 44 and a speaker unit 45; and a central processing unit (CPU) 47.

Here, the TMDS receiver 42 decodes the signal, which is converted to have a TMDS format by a TMDS transmitter of the external source, to be separated into the video signal, audio signal and control signal. The TMDS receiver 42 includes a signal converting chipset. The TMDS receiver 42 includes an equalization circuit to compensate loss in signal transmission, for example, to compensate signal weakening and noise generation.

Further, the CPU 47 reads the cable information from the memory 33 of the HDMI cable 30 connected to the HDMI port 41 through 12 C communication, and controls the TMDS receiver 42 to compensate the signal loss such as noise on the basis of the read cable information. Thus, the signal process is varied according to the characteristics of the cable, thereby sufficiently considering the noise generation.

According to an exemplary embodiment of the present invention, the display apparatus 40 includes the register to process the noise. The CPU 47 reads the cable information, thereby searching an optimal register value corresponding to the characteristics of the cable. At this time, the CPU 47 may include an operation program to search the optimal register value, and may refer to a data table for searching the optimal register value as necessary.

For example, the CPU 47 can set ‘0×C3’ as the optimal register value for the connection cable having a length of 7 m and more, and set ‘0×C1’ as the optimal register value for the connection cable having a length of 5 m and less.

Accordingly, the register value is set in order to more sensitively process the signal amplification and noise compensation as the length of the connection cable increases.

Here, the CPU 47 can be replaced by a micro controller unit (MCU) of the TMDS receiver 42.

Below, the operations of the display apparatus 40 according to an exemplary embodiment of the present invention will be described with reference to FIG. 3.

As shown in FIG. 3, at operation 101, the HDMI cable 30 is connected to the HDMI port 41. At operation 102, the CPU 47 reads the cable information from the memory 33 of the HDMI cable 30 through the 12 C communication.

At operation 103, the optimal register value for the noise process is determined according the read cable information. At operation 104, the optimal register value is set, and the CPU 47 controls the TMDS receiver 42 to process the received signal on the basis of the set optimal register value.

Thus, the display apparatus 40 performs the equalization process according to the characteristics of the cable, thereby solving a problem of the noise generation or the like.

In the foregoing exemplary embodiments, the present invention is applied to the HDMI cable by way of example, but not limited thereto. Alternatively, the present invention may be applied to a DVI cable or other interface cables, and a corresponding signal reproducer.

As described above, the present invention provides a media player, a control method thereof, and a media play system including the same, in which a signal is optimally processed according to characteristics of a connection cable.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A media play system comprising a media player and a media interface in which a signal is transmitted from an external source to the media player, the media play system comprising:
a cable in the media interface for transmitting the signal, and a memory in the media interface for storing cable information about characteristics of the cable, and
a connection unit in the media player connected to the cable, a signal processor in the media player for processing a signal input through the connection unit, and a controller in the media player for processing the input signal through the connection unit in accordance with the cable information.

2. The media play system according to claim 1, wherein the cable information comprises information about at least one of length, impedance or capacitance of the cable.

3. The media play system according to claim 3, wherein the media player comprises a register to process noise of the signal; and
wherein the controller determines an optimal register value for the noise process according to the characteristics of the cable by reading the cable information, and controls the signal processor to process the noise of the signal input through the connection unit in accordance with the optimal register value.

4. The media play system according to claim 3, wherein the signal processor comprises a transition minimized differential signaling (TMDS) receiver.

5. The media play system according to claim 4, wherein the media interface comprises a high-definition multimedia interface (HDMI) cable.

6. The media play system according to claim 5, wherein the controller comprises at least one of a micro controller unit (MCU) or a central processing unit (CPU).

7. A media player comprising a connection unit in which a media interface cable is connected for transmitting a signal from an external source, the media player comprising:
a signal processor for processing a signal input through the connection unit; and
a controller for reading cable information about characteristics of the media interface cable from a memory provided in the media interface cable, where the media interface cable is connected to the connection unit, and controlling the signal processor to process the input signal in accordance with the cable information.

8. The media player according to claim 7, wherein the cable information comprises information about at least one of length, impedance and capacitance of the media interface cable.

9. The media player according to claim 8, wherein the signal processor comprises a TMDS receiver.

10. The media player according to claim 9, wherein the media interface cable comprises a HDMI cable.

11. The media player according to claim 10, wherein the controller comprises at least one of a MCU or a CPU.

12. The media player according to claim 11, wherein the MCU is provided in the TMDS receiver.

13. The media player according to claim 12, wherein the MCU or the CPU reads the cable information from the memory through I2C communication.

14. The media player according to claim 13, wherein the memory comprises an electrical erasable programmable read only memory (EEPROM).

15. The media player according to claim 14, further comprising a register to process noise of the signal, and
wherein at least one of the MCU or the CPU determines an optimal register value according to the characteristics of the media interface cable by reading the cable information from the memory, and controls the TMDS receiver to process the noise of the input signal in accordance with the optimal register value.

16. A method of controlling a media player comprising a connection unit, which an HDMI cable is connected to, for transmitting a signal from an external source to a media player, the method comprising:
determining an optimal register value for processing noise of a signal according to characteristics of the HDMI cable by reading information about at least one of length, impedance or capacitance of the HDMI cable from a predetermined memory provided in the HDMI cable, where the HDMI cable is connected to the connection unit; and
processing the noise of the signal received through the connection unit in accordance with the optimal register value.
